(19) United States
(12) Patent Application Publication
(10) Pub. No.: US 2011/0100221 A1
(43) Pub. Date: May 5, 2011

(54) Air purifier

(76) Inventor: Fu-Chi Wu, Northridge, CA (US)

(21) Appl. No.: 12/588,895

(22) Filed: Nov. 2, 2009

(51) Int. Cl. B03C 3/011; B03C 3/36; B03C 3/016; B03C 3/38; B01D 27/08

(52) U.S. Cl. 96/16; 55/358; 55/344; 55/472; 55/473; 96/55; 96/63; 96/64; 96/224

(57) ABSTRACT

An air purifier includes a vertically disposed housing provided with a wire gauze filter, electric fans and air filter elements. The electric fans draw outside air around the floor vertically into the bottom air intake port toward the top air output port of the housing so that the flow of air, when passed out of the air output port, flows upwards to a certain elevation and is then diffused and lowered in all directions around the housing. By means of the traction of the flow of air, the pressure difference of the convection of air between the low air pressure and the high air pressure at the bottom and top sides of the housing, high concentration of car waste gas, micro dust particles, hair dust, micro fibers and other harmful industrial odors that fall to the floor due to the effect of gravity or floating nearly above the floor are sucked into the inside of the housing by the low air pressure zone at the open bottom side of the housing and then removed by the filter elements.

### BACKGROUND OF THE INVENTION

1. Field of the Invention

The present invention relates to air cleaning technology and more particularly, to an air purifier, which comprises a housing disposed perpendicular to the floor and having its air intake port disposed at the bottom side and its air output port disposed at the top side so that the electric fan that is mounted inside of the housing draws in air from the open bottom air intake port for causing the intake flow of air to go upwardly through a longitudinal air passage of the housing to the outside via the top air output port, thereby forming a pressure difference of convection of air between a low air pressure at the open bottom side and a high air pressure at the top side. When the flow of air goes upwardly out of the air output port, it flows upwards to a certain elevation and is then diffused and lowered in all directions from the center of the housing. By means of the traction of the flow of air during continuous operation of the electric fan to draw in air, the pressure difference of the convection of air between the low air pressure at the open bottom side and the high air pressure at the top side, high concentration of car waste gas, micro dust particles, hair dust, micro fibers and other harmful industrial odors that fall to the floor due to the effect of gravity or floating nearly above the floor are sucked into the inside of the housing by the low air pressure zone at the open bottom side of the housing and then removed by the replaceable filter unit in the housing, thereby improving the air purification effect. Different air treatment means may be installed in the housing to enhance the filtration effect.

2. Description of the Related Art

Following fast business and industry development, industrial and business activities are intensively carried on in particular places. However, waste gas from industries, automobiles and other transportation vehicles affects the quality of water, sunlight and air around people, threatening human health. Air is a vital element of life. However, the air around us contains invisible harmful substances. High concentration of pollutants such as micro particles of car waste gas, tinny hairs, micro fibers and industrial waste gas and odor substances are floating in air around the floor, table top and desk top. These harmful substances will fall to or floating nearly above the floor, table top and desk top subject to the effect of gravity when it is still. When a wind is induced as we are walking or when a natural wind occurs, the harmful substances deposited on or floating nearly above the floor, table top or desk top will be moved with the wind upwards into the higher level of the indoor air, and people within this area will breathe in these harmful substances, causing diseases to occur.

Many different air purifiers are known and commercially available. These commercial air purifiers commonly use an electric fan to cause circulation of currents of air through a housing thereof and air filter elements to remove harmful substances from the air passing therethrough. Advanced air purifiers or air purifiers may be equipped with extra air treatment devices, such as electro-static precipitator, an ionizer, ultraviolet lamp, photo catalytic panel and etc. to enhance the air cleaning work and/or to kill microbes. However, regular air purifiers commonly have the air intake port set on the front side and the air output port on the rear side for horizontal circulation of air. There is known another commercial design that has top and bottom air intake port and an air output port arranged at one side for circulation of air. However, the air intake port and output port design of conventional air purifiers cannot draw in air from all different directions to effectively carry in harmful micro dust particles, flower pollen, hair dust and other industrial pollutants and odors that are accumulated on or suspending above the floor, table top and desk top for treatment through the internal air filter elements and air treatment components. Therefore, conventional air purifiers have a low filtration efficiency. Further, the wire gauze filter of a conventional air purifier is to be cleaned or replaced several months after use. This does not mean a high quality of air but just because the functioning of the air purifier cannot effective draw in air in all directions to carry in dust particles, flower pollen and other pollutants that are deposited on or floating nearly above the floor, table top and desk top.

Therefore, it is desirable to provide an air purifier, which eliminates the aforesaid problem.

### SUMMARY OF THE INVENTION

The present invention has been accomplished under the circumstances in view. It is one object of the present invention to provide an air purifier, which uses an electric fan to cause formation of convection currents circulating upwardly through a longitudinal air passage and air filter elements in the longitudinal air passage, thereby effectively cleaning the air.

To achieve this and other objects of the present invention, an air purifier comprises a housing for positioning on the floor, the housing comprising an air intake port with open end located on a bottom side thereof and spaced above the floor for guiding in outside air, an air output port located on a top side thereof for guiding inside air out of the housing, a longitudinal air passage in air communication between the air intake port and the air output port; a wire gauze filter covered on the air output port of the housing; a plurality of air filter elements mounted in the longitudinal air passage inside the housing for removing solid matters from air passing through the longitudinal air passage; and at least one electric fan mounted in the longitudinal air passage inside the housing and controlled to draw outside air around the floor into the air intake port toward the air output port. Subject to the design of the vertically or substantially vertically extended air passage, a low air pressure and a high air pressure occur in the bottom side and top side of the housing respectively during operation of the electric fan to draw air into the inside of the housing through the bottom air intake port. When the intake flow of air goes upwardly out of the air output port, it flows upwards to a certain elevation and is then diffused and lowered in all directions from the center of the housing. By means of the traction of the flow of air during continuous operation of the electric fan to draw in air, the pressure difference of the convection of air between the low air pressure at the open bottom side of the housing and the high air pressure at the top side of the housing, high concentration of car waste gas, micro dust particles, hair dust, micro fibers and other harmful industrial odors that fall to the floor due to the effect of gravity or floating nearly above the floor are sucked into the inside of the housing by the low air pressure zone at the open bottom side of the housing and then removed by the air filter elements. Further, air treatment devices are mounted inside the housing for purifying air passing through the longitudinal air passage and killing microbes. These air treatment devices include electro-static precipitator, an ionizer, an ultraviolet lamp and a photo catalytic panel.

### BRIEF DESCRIPTION OF THE DRAWINGS

FIG. 1 is an exploded view of an air purifier in accordance with a first embodiment of the present invention.

FIG. 2 is a schematic sectional view of the air purifier in accordance with the first embodiment of the present invention.

FIG. 3 is an oblique elevation of the air purifier in accordance with the first embodiment of the present invention.

FIG. 4 is a schematic drawing of the first embodiment of the present invention, showing convection currents of air through the air purifier.

FIG. 5 is a schematic sectional view of an air purifier in accordance with a second embodiment of the present invention.

FIG. 6 is an exploded view of an air purifier in accordance with a third embodiment of the present invention.

FIG. 7 is a schematic sectional view of the third embodiment of the present invention, showing the air purifier in operation.

FIG. 8 is a schematic drawing, showing an air purifier in accordance with a fourth embodiment of the present invention.

FIG. 9 is a schematic drawing, showing an air purifier in accordance with a fifth embodiment of the present invention.

FIG. 10 is a schematic drawing, showing an air purifier in accordance with a sixth embodiment of the present invention.

### DETAILED DESCRIPTION OF THE PREFERRED EMBODIMENT

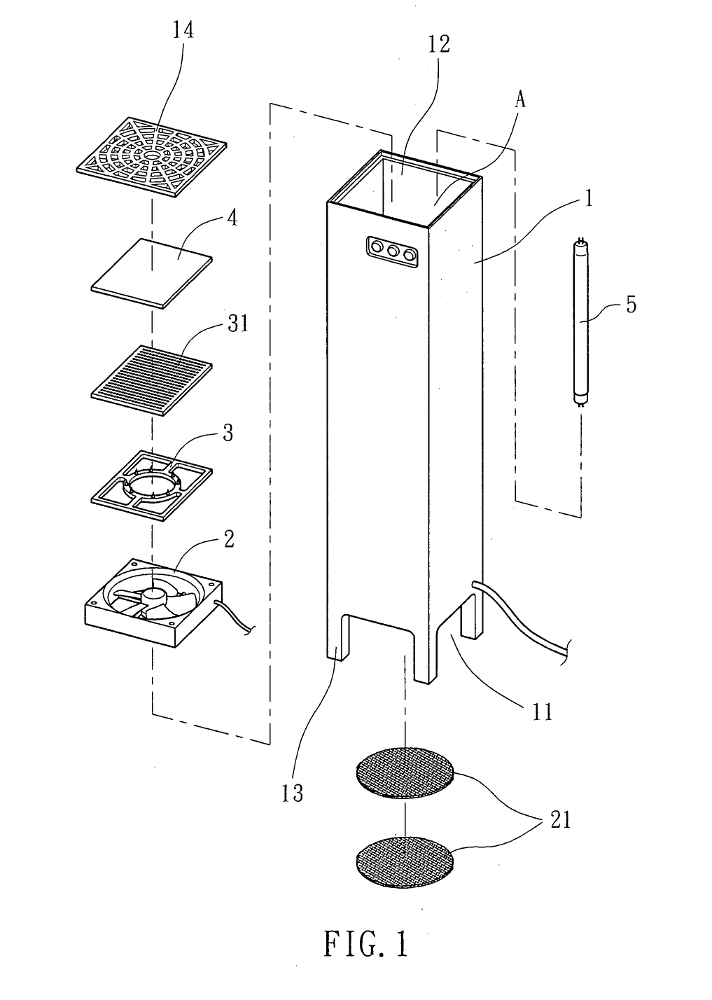

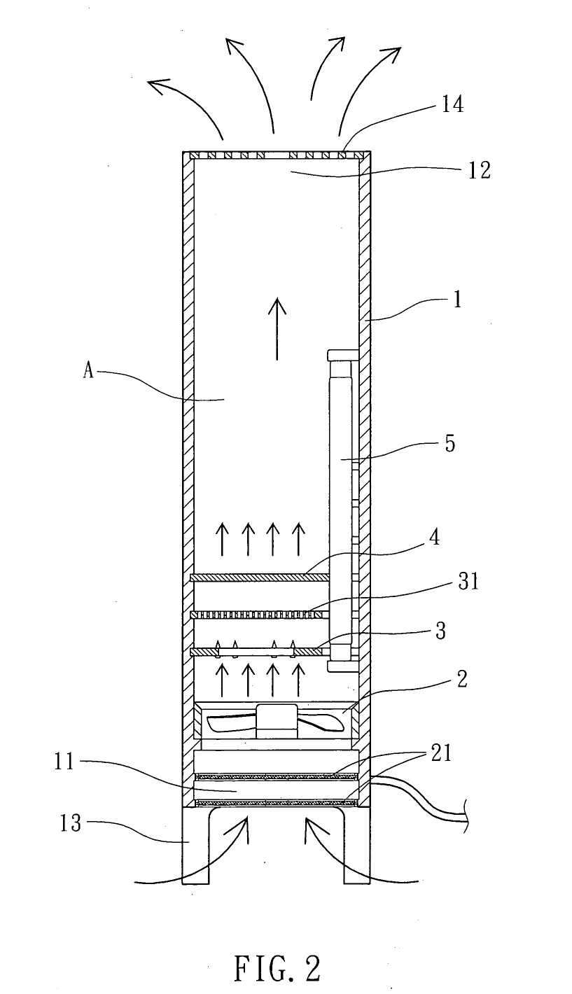

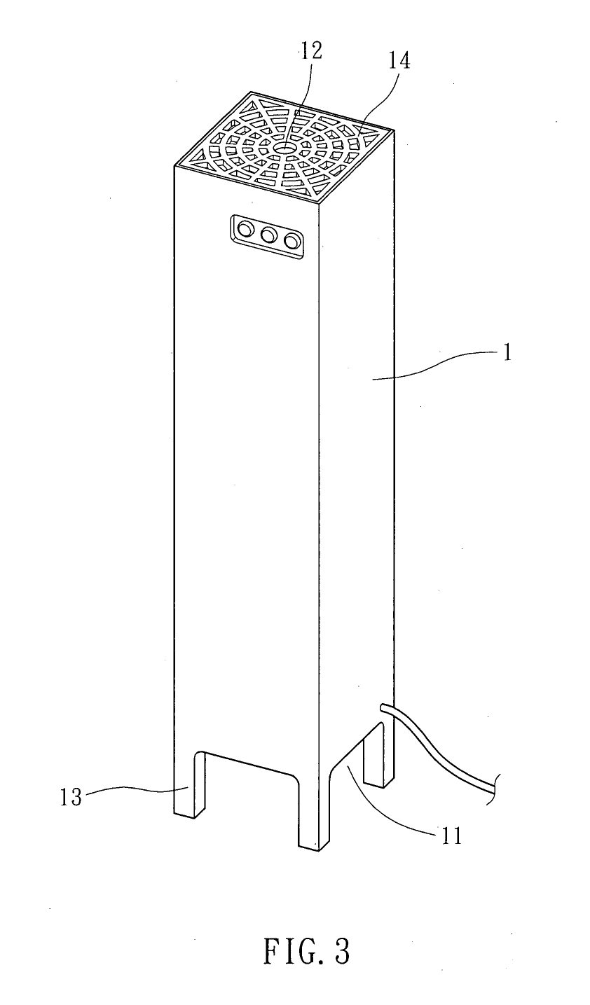

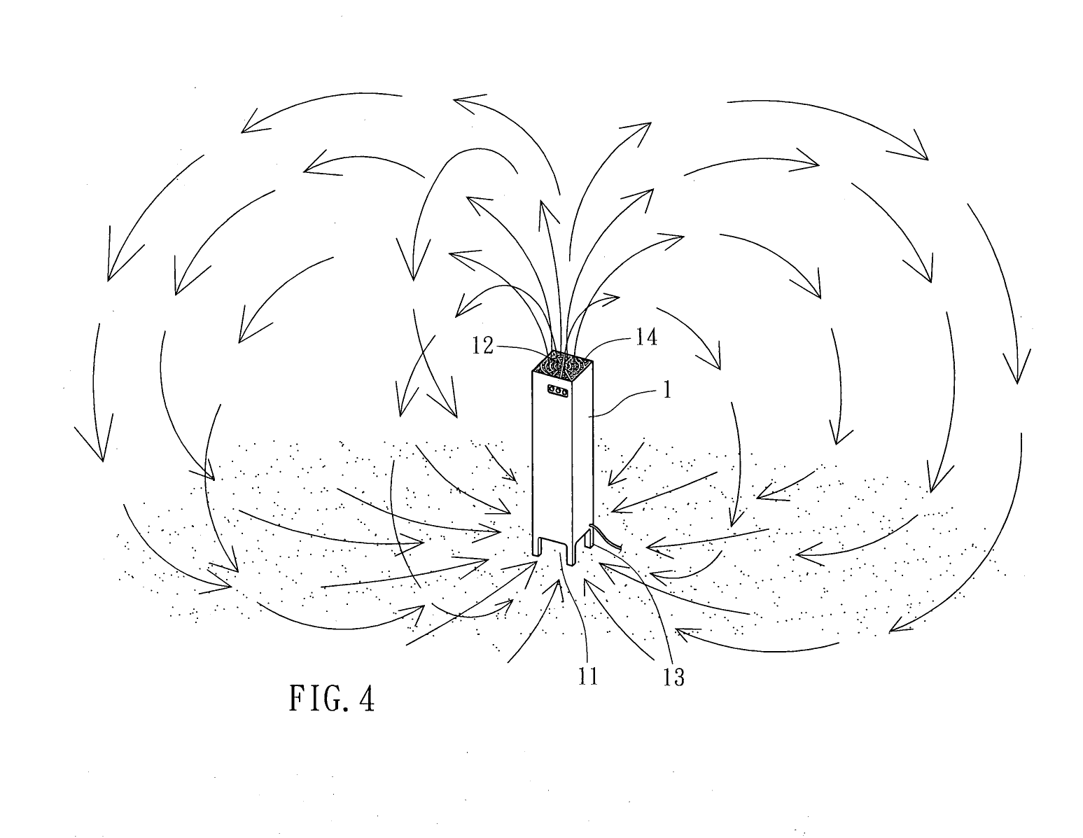

Referring to FIGS. 1˜4, an air purifier in accordance with a first embodiment of the present invention is shown comprising a housing 1, a wire gauze filter 14, an electric fan 2, two air filter elements 21, an ionizer 3, an electro-static precipitator 31, a photo catalytic panel 4, an ultraviolet lamp 5.

The housing 1 comprises an air intake port 11 located on the bottom side thereof, an air output port 12 located on the top side thereof, a longitudinal air passage A in air communication between the air intake port 11 and the air output port 12 and a plurality of legs 13 spaced around the bottom side for positioning on the floor to keep the air intake port 11 above the floor at a predetermined distance.

The wire gauze filter 14 is covered on the air output port 12 of the housing 1.

The electric fan 2 is transversely mounted in the longitudinal air passage A inside the housing 1 near the air intake port 11, and controlled to draw outside air from the space around the floor upwardly into the air intake port 11 toward the air output port 12. Continuous operation of the electric fan 2 causes convection currents of air flowing through the longitudinal air passage A, and an air pressure difference between the top and bottom sides of the air purifier occurs, facilitating convection of air so that the output flow of air is diffused upwards and then downwards in all directions around the housing and then drawn into the air intake port by the electric fan. When the intake flow of air goes upwardly out of the air output port 12, it flows upwards to a certain elevation and is then diffused and lowered in all directions from the center of the housing 1. By means of the traction of the flow of air during continuous operation of the electric fan to draw in air, the pressure difference of the convection of air between the low air pressure at the open bottom side of the housing 1 and the high air pressure at the top side of the housing 1, high concentration of car waste gas, micro dust particles, hair dust, micro fibers and other harmful industrial odors that fall to the floor, desk top or table top due to the effect of gravity or floating nearly above the floor, desk top or table top are sucked into the inside of the housing 1 by the low air pressure zone at the open bottom side of the housing 1 and then removed by the air filter elements 21 and the electro-static precipitator 31.

The two air filter elements 21 are detachably mounted inside the housing 1 beneath the electric fan 2 for removing solid matters from the intake currents of air.

The electro-static precipitator 31 is transversely detachably mounted in the longitudinal air passage A inside the housing 1 above the electric fan 2 for arresting solid particles. After a long use, the electro-static precipitator 31 can be taken out of the housing 1 for cleaning conveniently.

The ionizer 3 is transversely mounted in the longitudinal air passage A inside the housing 1 between the electric fan 2 and the electro-static precipitator 31 for causing pollen, mold spores, dust, animal dander and other allergens floating in the air to be attracted to each other, forming clumps. These clumps of particles are then arrested by the electro-static precipitator 31.

The ultraviolet lamp 5 is mounted in the longitudinal air passage A at one side within the housing 1, and controlled to emit ultraviolet light rays around the photo catalytic panel 4.

The photo catalytic panel 4 is transversely mounted in the longitudinal air passage A inside the housing 1 above the electro-static precipitator 31. Under the radiation of the ultraviolet light rays from the ultraviolet lamp 5, photo catalysis of titanium dioxide of the photo catalytic panel 4 causes photo-decomposition of organic pollutants.

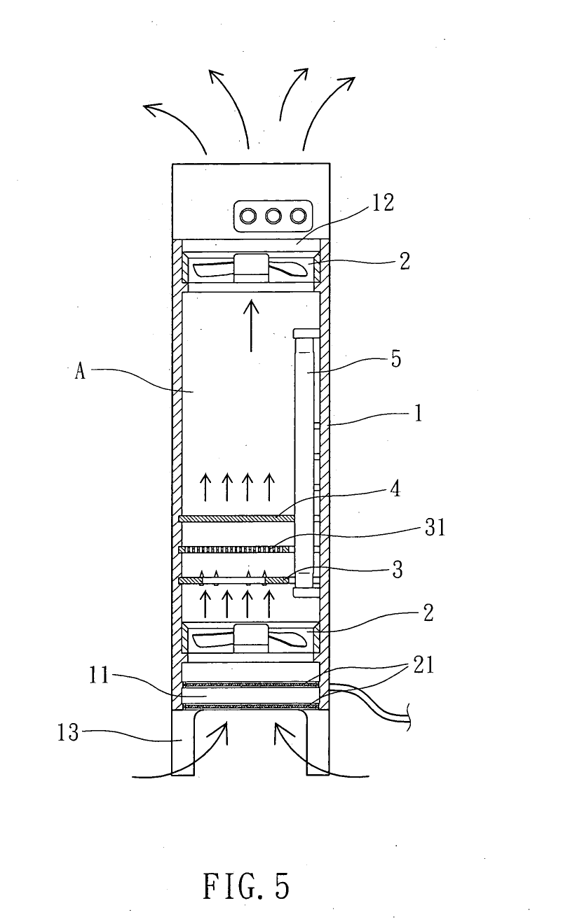

FIG. 5 shows an air purifier in accordance with a second embodiment of the present invention. This second embodiment is substantially similar to the aforesaid first embodiment with the exception that an extra electric fan 2 is transversely mounted in the longitudinal air passage A inside the housing 1 near the air output port 12.

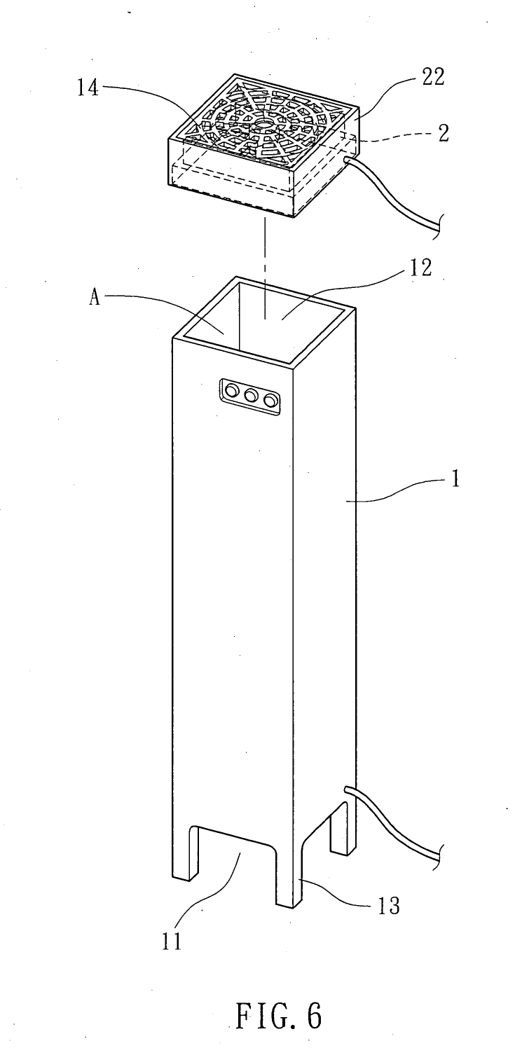

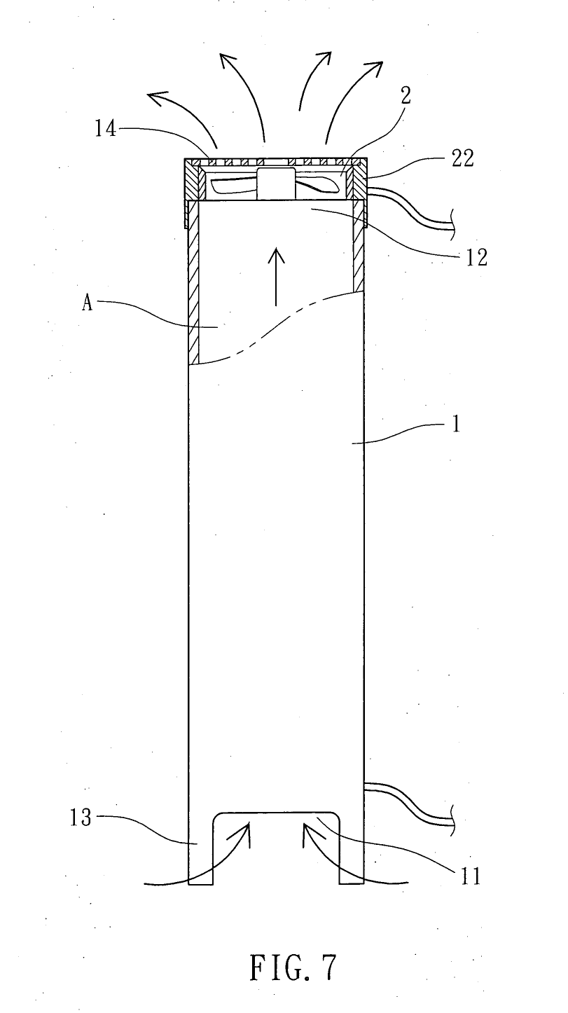

FIGS. 6 and 7 show an air purifier in accordance with a third embodiment of the present invention. According to this third embodiment, the electric fan 2 is incorporated with the wire gauze filter 14 in a fan guard 22 and transversely mounted in the air output port 12 of the housing 1.

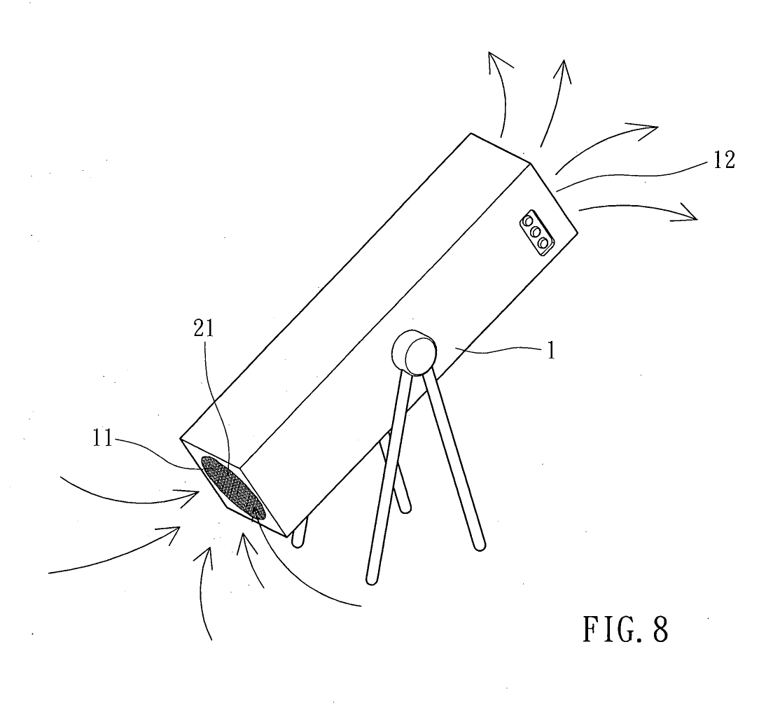

FIG. 8 shows an air purifier in accordance with a fourth embodiment of the present invention. This fourth embodiment is substantially similar to the aforesaid first embodiment with the exception that the housing 1 according to the fourth embodiment is to be positioned on the floor in a tilted condition.

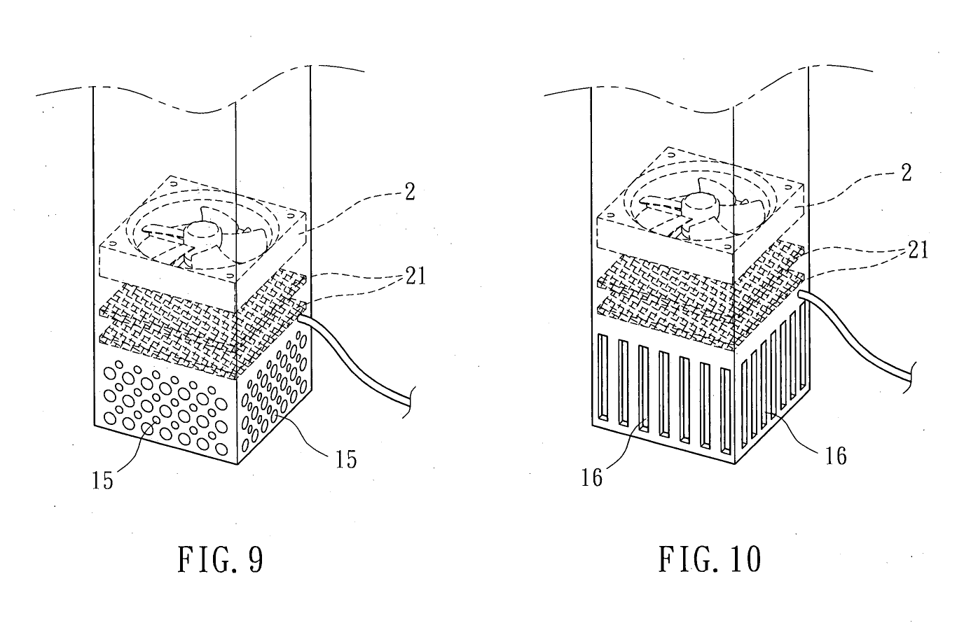

FIG. 9 shows an air purifier in accordance with a fifth embodiment of the present invention. According to this fifth embodiment, the housing 1 eliminates the aforesaid legs 13 and has multiple air vents 15 arranged around the periphery in air communication with the longitudinal air passage defined therein. The air holes 15 form an air intake port. Further, the air holes 15 can be made in any desired shape.

FIG. 10 shows an air purifier in accordance with a sixth embodiment of the present invention. According to this sixth embodiment, the housing 1 eliminates the aforesaid legs 13 and has multiple elongated slots 16 cut through the periphery in air communication with the longitudinal air passage therein. These longitudinal slots 16 form an air intake port.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An air purifier, comprising:
a housing for positioning on the floor, said housing comprising an air intake port located on a bottom side with open end thereof and spaced above the floor for guiding in outside air, an air output port located on a top side thereof for guiding inside air out of said housing, a longitudinal air passage in air communication between said air intake port and said air output port;
a plurality of air filter elements mounted in said longitudinal air passage inside said housing for removing solid matters from air passing through said longitudinal air passage; and
at least one electric fan mounted in said longitudinal air passage inside said housing and controlled to draw outside air around the floor into said air intake port toward said air output port in vertical for causing a relative low pressure to be produced around the space beneath said housing and a relative high pressure to be produced around the space above said housing so that a convection of air circulates through said housing in all directions to carry micro dust particles, hair dust, micro fibers and other harmful industrial odors from the floor, table top and desk top into said housing for removal by said filter elements.

2. The air purifier as claimed in claim 1, wherein said housing comprises a plurality of legs extended from the bottom side thereof for positioning on the floor to keep said air intake port above the floor.

3. The air purifier as claimed in claim 1, wherein said air filter elements are replaceable.

4. The air purifier as claimed in claim 1, further comprising air treatment means mounted inside said housing for purifying air passing through said longitudinal air passage.

5. The air purifier as claimed in claim 4, wherein said air treatment means comprises an electro-static precipitator and an ionizer.

6. The air purifier as claimed in claim 4, wherein said air treatment means comprises an ultraviolet lamp.

7. The air purifier as claimed in claim 4, wherein said air treatment means comprises an ultraviolet lamp and a photo catalytic panel.

8. The air purifier as claimed in claim 1, wherein said at least one electric fan includes two electric fans respectively mounted in said longitudinal air passage inside said housing and respectively disposed near said air intake port and said air output port for drawing outside air into said air intake port toward said air output port.

9. The air purifier as claimed in claim 1, wherein one said electric fan is mounted in said longitudinal air passage inside said housing in proximity to said air intake port.

10. The air purifier as claimed in claim 1, wherein one said electric fan is mounted in said air output port of said housing.

11. The air purifier as claimed in claim 10, wherein the electric fan that is mounted in said air output port of said housing is protected inside a fan guard of a separated component.

12. The air purifier as claimed in claim 1, wherein said housing is mountable on the floor in a tilted position.

13. The air purifier as claimed in claim 1, wherein said housing comprises a plurality of air holes arranged around the periphery thereof in communication with a bottom side of said longitudinal air passage, thereby forming said air intake port.

14. The air purifier as claimed in claim 1, wherein said housing comprises a plurality of elongated slots cut through the periphery thereof in communication with a bottom side of said longitudinal air passage, thereby forming said air intake port.
